(19) United States
(12) Patent Application Publication
(10) Pub. No.: US 2015/0095796 A1
(43) Pub. Date: Apr. 2, 2015

(54) LOADING A DATABASE INTO THE CLOUD

(71) Applicant: Oracle International Corporation, Redwood Shores, CA (US)

(72) Inventors: Syme Kutz, Redwood Shores, CA (US); Joyce Scapicchio, Redwood Shores, CA (US); Kristopher Leland Rice, Redwood Shores, CA (US)

(21) Appl. No.: 14/485,614

(22) Filed: Sep. 12, 2014

Related U.S. Application Data
(60) Provisional application No. 61/883,882, filed on Sep. 27, 2013.

(51) Int. Cl. G06F 3/0486; G06F 17/30; H04L 29/08; G06F 3/0481; G06F 3/0482

(52) U.S. Cl. CPC G06F 3/0486; G06F 3/04817; G06F 3/0482; H04L 67/06; H04L 67/1097; G06F 17/30575
USPC 715/748

(57) ABSTRACT

Techniques are described herein for loading data into a database cloud service. In an embodiment, one or more database objects are added to a virtual cart in response to first user input. In response to second user input, the one or more database objects are deployed the one or to the database cloud service. Deploying the one or more database objects to the database cloud service may comprise generating, based at least in part on the one or more database objects in the virtual cart, a set of one or more files for loading the database objects into a target database associated with the database cloud service and sending the set of one or more files to the database cloud service.

### CROSS-REFERENCE TO RELATED APPLICATIONS

### Benefit Claim

This application claims the benefit of Provisional application 61/883,882, filed Sep. 27, 2013, the entire contents of which is hereby incorporated by reference as if fully set forth herein, under 35 U.S.C. §119(e). This application is related to U.S. application Ser. No. ______ (Attorney Docket No. 50277-4147), filed ______, 2013, the entire contents of which is hereby incorporated by reference as if fully set forth herein and referred to herein as CLOUD DATABASE LOCKDOWN. This application is also related to U.S. application Ser. No. ______ (Attorney Docket No. 50277-4148), filed ______, 2013, the entire contents of which is hereby incorporated by reference as if fully set forth herein and referred to herein as CLOUD DATABAE CONNECTION MULTIPLEXING.

### FIELD OF THE INVENTION

The present disclosure relates to cloud computing and, more specifically, to techniques for loading database data into a cloud service.

### BACKGROUND

Cloud computing involves the use of computing resources (hardware and software) that are delivered as a service over a network (typically the Internet). One type of cloud computing service is referred to as platform as a service (PaaS). In the PaaS model, the user/consumer creates software using tools and/or libraries from the provider. The user also controls software deployment and configuration settings. The provider provides the networks, servers, storage and other services.

PaaS offerings facilitate the deployment of applications without requiring the users to incur the cost and complexity of buying and managing the underlying hardware and software, and provisioning hosting capabilities. PaaS offerings may include, for example, facilities for application hosting, application design, application development, application testing, team collaboration, web service integration and marshalling, database integration, security, scalability, storage, persistence, state management, application versioning, application instrumentation and developer community facilitation. These services are generally provisioned as an integrated solution over the web.

Another type of cloud computing service is referred to as database as a service (DBaaS). In the DBaaS model, the user has access to a database running on a cloud computing platform. The user typically interacts directly with the database and is given their own database instance in a virtual machine. The DBaaS may also grant the user greater control of the configuration settings of the database than is typical in the PaaS model.

In some instances, the user may wish to deploy preexisting database data to the cloud database. For example, when an application is deployed to a cloud platform, some amount of data may already exist for the application that resides in a user database outside of the cloud platform. Loading the data from one database to another may be a cumbersome and resource-intensive task, depending on the amount of data that needs to be loaded.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Various embodiments are illustrated by way of example, and not by way of limitation, in the figures of the accompanying drawings and in which like reference numerals refer to similar elements and in which:

FIG. 1 is a block diagram depicting an example system that may be used to provide database cloud services to consumers, according to an embodiment;

FIGS. 2A and 2B are screenshots illustrating an example virtual cart that may be used to load objects into a database cloud service, according to an embodiment;

FIG. 3 is a screenshot illustrating an example of adding an object to a virtual cart, according to an embodiment;

FIGS. 4A and 4B are flowcharts illustrating example processes for loading data into a database cloud service, according to an embodiment;

FIGS. 5A and 5B are screenshots illustrating an example interface for deploying contents of a virtual cart to a database cloud service, according to an embodiment;

FIG. 6 is a screenshot of an export dialog that indicates the deployment of object to the database cloud service has started, according to an embodiment;

FIG. 7 is a screenshot depicting an example interface for determining the status of a deployment, according to an embodiment;

FIG. 8 is a block diagram depicting a computer system upon which an embodiment may be implemented.

### DETAILED DESCRIPTION

Techniques are described herein for loading database objects and other data into a database cloud service. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

According to techniques described herein, data may be loaded flexibly and efficiently into a database cloud service. In some embodiments, a virtual cart may be used to facilitate the loading process. The virtual cart allows consumers to quickly identify a set of one or more database objects that the user would like to load into a database cloud service. In addition, the virtual cart allows consumers to identify scripts that may be run by the database cloud service, providing the consumer with robust control over the loading process.

### Database Cloud Service

A “database cloud service” is a service that provides access to a database system running on a cloud platform. In order to use the service, a consumer creates an account through a registration or subscription process established by the service provider. The account may correspond to an individual user or a set of users, depending on the particular implementation. For example, an account may correspond to a particular organization that has a plurality of users that share access to a particular database cloud service. Each account may also be associated with one or more database cloud services, where the data loaded into each individual database cloud service is logically separated from data in other database cloud services within the cloud platform.

A “consumer” of a database cloud service is a set of one or more users associated with an individual account. When there are multiple users associated with an account, the users may have equal access privileges or the access privileges may vary from user to user or for different groups of users. For example, each account may have a particular user that acts as an account administrator. Certain account privileges may be reserved solely for the administrator. Example privileges that may be reserved for the account administrator include, without limitation, adding, defining, and deleting users for the corresponding database cloud service; paying fees, if any, associated with the account; and monitoring, configuring, and selecting administrative parameters for the respective account.

The cloud computing model of the database cloud service may vary from implementation to implementation. In an embodiment, the database cloud service may have some characteristics of a Platform-as-a-Service (PaaS) rather than a Database-as-a-Service (DBaaS). For example, the database cloud service may give the user programmatic access to an underlying database within the cloud platform through a structured query language (SQL) or a procedural language, such as a procedural language extension to SQL (e.g., PL/SQL). The user's programs may be executed from inside the cloud platform and/or through web services. As another example, the database cloud service may be a fully managed service, without requiring the user to perform maintenance operations on the underlying database or system software within the cloud. In addition or alternatively, the database cloud service may manage the configuration parameters for a database instance rather than the user and may allow multiple tenants on a single database instance. In other embodiments, the database cloud service may have one or more characteristics of a DBaaS. For example, in some embodiments the user may be permitted to configure the database system settings In other embodiments, the database cloud service may be offered as, or in conjunction with, a Software-as-a-Service (SaaS), Middleware-as-a-Service (MWaaS), Infrastructure-as-a-Service (IaaS), or some other cloud computing solution.

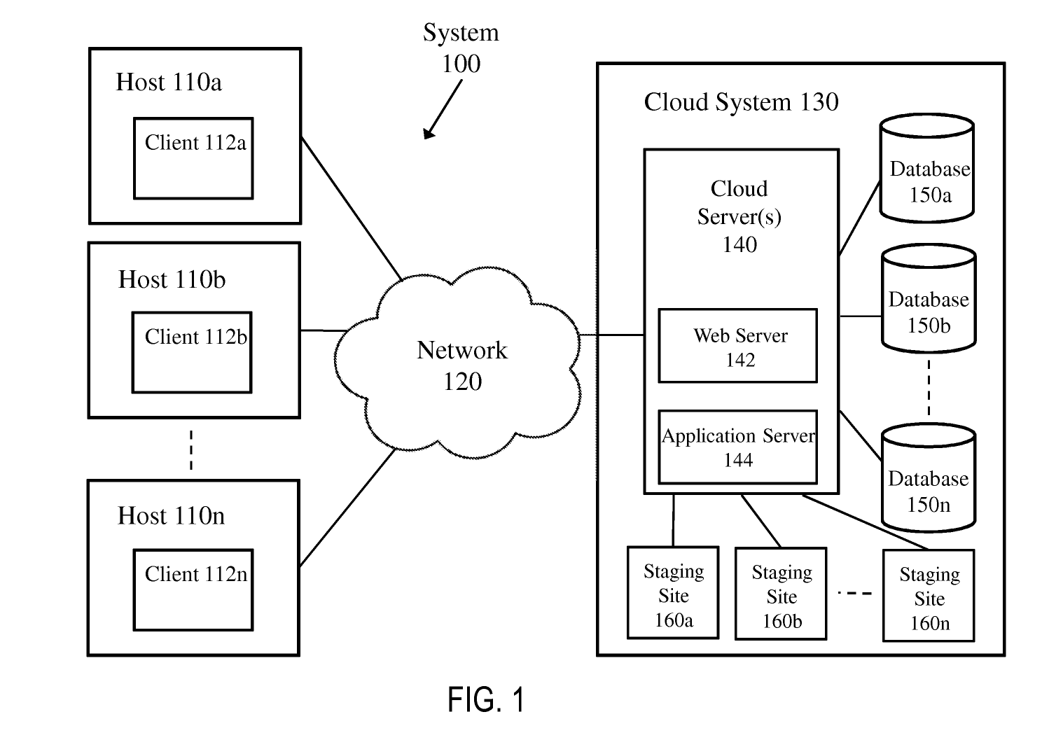

FIG. 1 is a block diagram depicting an example system that may be used to provide database cloud services to consumers, according to an embodiment. System 100 includes one or more network hosts 110a to 110n, which are connected to network 120. Network hosts 110a to 110n may be any computing device capable of sending and receiving data over network 120. Examples include, without limitation, devices that implement the Internet Protocol Suite (IP hosts), such as desktop computers, laptops, tablets, and mobile phones. Network hosts 110a to 110n include clients 112a to 112n, which act as interfaces between the consumers and their respective database cloud services. Each of clients 112a to 112n may comprise a set of one or more software applications which may be used by a consumer to register for a database cloud service and/or access the service. For example, clients 112a to 112n may include, without limitation a web browser, an integrated development environment (IDE) such as SQL Developer, and other applications that provide an interface for interacting with a web server. Clients 112a to 112n may comprise a graphical user interface (GUI) for receiving input and displaying output to consumers.

Network 120 may comprise one or more private and public computer networks (e.g., the Internet) that communicate according to a set of communication protocols (e.g., protocols included in the Internet Protocol Suite). In an embodiment, clients 112a to 112n communicate with cloud system 130 through a web application programming interface (API), such as through web services that follow the architectural principals of representational state transfer (RESTful web services). RESTful web services may include the following characteristics: the web services explicitly use methods of the Hypertext Transfer Protocol (HTTP), the web services are accessible through URIs, and the services are stateless. Accordingly, clients 112a to 112n may access their respective services by sending HTTP and HTTP Secure (HTTPS) requests to cloud system 130. The term “HTTP request” as used herein may refer, without limitation, to both HTTP and HTTPS requests. In other embodiments, other communication methods may be used for the cloud connection. Examples may include, without limitation, the Simple Object Access Protocol (SOAP) and other non-REST-compliant web services.

Cloud system 130 includes cloud server 140, one or more database systems 150a to 150n, and one or more staging sites 160a to 160n. Cloud server 140 may act as a central hub to receive and service requests from various consumers. Cloud server 140 may comprise web server 142 and application server 144. Web server 142 performs access control, such as verifying a consumer's authentication credentials and establishing secure connections for the consumer. Web server may store consumer requests in an administrative database for subsequent processing by application server 144. The administrative database (not shown) may be provisioned into one of database systems 150a to 150n. Application server 144 may include an event handler that polls the administrative database for consumer requests that have not yet been processed. Application server 144 may route and process the requests according to techniques described in CLOUD DATABAE CONNECTION MULTIPLEXING. Although only one cloud server 140 is depicted, in other implementations, cloud system 130 may include multiple cloud servers. For example, one cloud server may service a plurality of databases physically located in one region while a second cloud server may be used to service a plurality of databases physically located in a different region. In addition, each cloud server may include multiple web servers, application servers, and/or FTP servers. Each cloud and/or application server is capable of routing to multiple database systems, establishing a one-to-many relationship between the server that receives consumer requests and the database systems that store consumer data.

Databases systems 150a to 150n manage and store organized collections of data for a plurality of consumers. Databases 150a to 150n collectively or a subset of one or more of databases 150a to 150n may be referred to herein as a “cloud database”. Each of databases systems 150a to 150n may comprise a database server that provides application server 144 (which may comprise a database client) with access to an underlying database. Each of database systems 150a to 150n may correspond to a different database instance comprising a set of memory structures and/or processes used by a database management system (DBMS) to manage and access files stored in an underlying database. For example, a database instance may include, without limitation, data caches for storing memory retrieved from the database, log writing processes for writing data to a log in the database, and/or input/output (I/O) processes for interacting with database files on disk. Cloud server 140 may be communicatively coupled to database systems 150a to 150n via one or more data communication networks, such as a Local Area Network (LAN), or via a direct physical connection.

Staging sites 160a to 160n act as a temporary storage locations for files used during the loading process described herein. Each staging site 160a to 160n may comprise a File Transfer Protocol (FTP) server that acts as a communication interface between clients 112a to 112n and storage within the staging site. The FTP server may perform access controls, such as verifying a consumer's authentication credentials for accessing the respective staging site, using a secure FTP protocol (SFTP). A consumer's authentication credentials for accessing the staging site may be the same or different than the credentials for accessing data in databases 150a to 150n, depending on the particular implementation.

### Creating a Cloud Connection

A “cloud connection” refers to a connection to a database cloud service. A cloud connection may differ from a standard database (or “non-cloud”) connection in one or more respects. In a cloud connection, a client does not form a direct connection with a database system, but accesses the database system using web services provided by servers running on a cloud platform. For example, the client may interact with a cloud system by sending Hypertext Transfer Protocol (HTTP) messages to web server 142. In response, cloud system 130 may establish a database connection to one of database systems 150a to 150n, such as described in CLOUD DATABAE CONNECTION MULTIPLEXING. With a non-cloud database connection, a client may connect directly to a database system without using a web application programming interface (API) or interacting with a cloud service. For example, the client may interact directly with a database server by using a connection string and a connection driver or may interact directly with local disk storage.

Client requests sent over a cloud connection may be processed in a stateless manner. For instance, each HTTP requests received may be processed as independent transactions that are unrelated to any previous HTTP requests sent by the consumer. The server does not store state information once the request has been fully processed. With a non-cloud database connection, the database server may maintain state information between various client requests. For example, the database server may hold open a database cursor and/or a database session between consumer requests.

In an embodiment, the same client application may be used to access data from both cloud and non-cloud database connections. For example, the client may concurrently connect to both a local database and to the database cloud service. The client application may allow the consumer to add, delete, modify, view, and/or otherwise access data in the cloud database and the local database through the same GUI. This may facilitate the loading process described further herein.

### Virtual Cart

A virtual cart acts a container that holds database objects (or definitions of the database objects) that a user would like to load to the user's database cloud service. The virtual cart may be or otherwise comprise a list of data for identifying the database objects that is updated in response to a user interacting with a virtual cart interface. Multiple objects may be added to an individual virtual cart, and all objects within a cart may be part of the same data upload deployment. A “database object” may be any logical entity used to store or reference data. Example database objects include, without limitation, tables, views, indexes, and stored procedures.

The virtual cart may have a GUI interface comprising one or more graphical user interface (GUI) objects that are displayed to an end user. The GUI interface for the virtual cart may be incorporated into the GUI for other client software, such as an IDE, or presented through a web browser. The manner in which the cart is displayed to the end user may vary from implementation to implementation. For example, when closed, the cart may be represented as a menu item (e.g., an element in a drop-down menu) and/or as an icon. When open, the cart may be represented as a resizable window. Thus, the term “cart” is not intended to delineate any particular form or shape for a GUI interface.

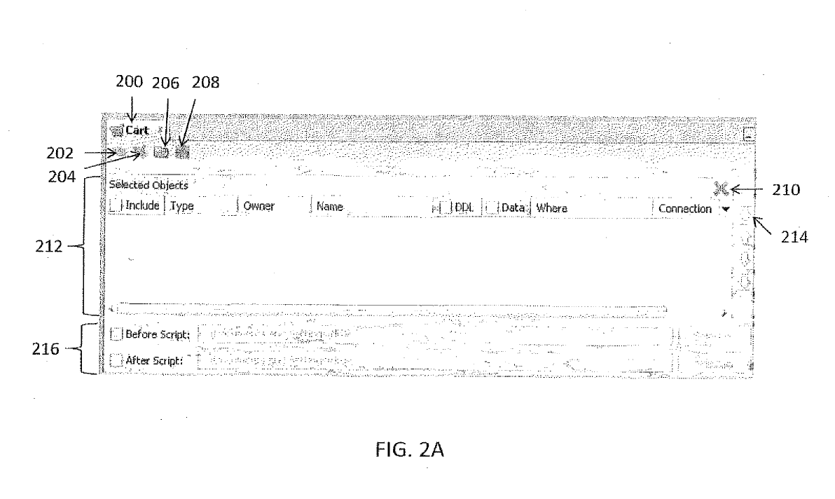

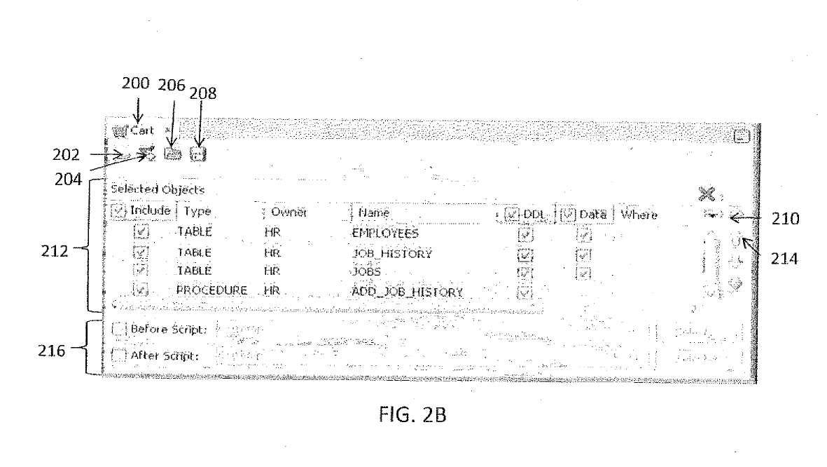

FIGS. 2A and 2B are screenshots of an example virtual cart interface, according to an embodiment. FIG. 2A depicts an example virtual cart interface when the virtual cart is empty, and FIG. 2B depicts an example virtual cart that contains multiple objects. Virtual cart 200 includes a GUI interface that facilitates deploying objects to the database cloud service. The GUI interface includes deploy cloud icon 202, deploy icon 204, open cart icon 206, save cart icon 208, and delete row icon 210. The GUI interface of virtual cart 200 further includes selected objects area 212, arrow buttons 214, and script field 216. The virtual cart interface depicted by the figures is given by way of example, and not by way of limitation. In other embodiments, different interfaces may be used. For example, the shape, function, and/or placement of GUI objects in the virtual cart may vary from implementation to implementation. In addition, the virtual cart may include additional interface elements that confer additional functionality to the virtual cart and/or may omit some or all of the interface elements depicted herein.

Referring to the virtual cart interface depicted in FIGS. 2A and 2B, deploy cloud icon 202 allows the user to control deployment of database object(s) within virtual cart 200 to the user's database cloud service. By selecting this icon, the user begins the data load process for objects within virtual cart 200. When the virtual cart is empty, deploy cloud icon 202 may be inactive since there is no data in the cart to deploy to the database cloud service. Deploy cloud icon 202 becomes active when one or more database objects are included in the cart and when a cloud connection is available.

Deploy icon 204 functions similarly to deploy cloud icon 202, except that the deploy icon 204 is used when loading database objects in virtual cart 200 to non-cloud database connections. For example, deploy icon 204 may be used to begin the load process for objects within the cart from one local database to another local database. Deploy icon 204 becomes active when one or more database objects are included in the cart.

Open cart icon 206 allows a user to open a saved cart by specifying a file with the cart contents. Upon selecting this icon 206, the user may be presented with a dialog box that allows the user to browse for the file and/or specify the file path and file name of the cart that the user would like to open. The cart file stores information about the contents of the corresponding virtual cart. For example, the cart file may store a list of metadata for each of the database objects included within the virtual cart. Example metadata that may be maintained for each of the database objects includes, without limitation, a respective database connection for accessing the database object, an object type for the database object, a database schema associated with the database object, and a name of the database object. The format of the cart file may vary from implementation to implementation. Example formats include, without limitation, a JavaScript Object Notation (JSON) format and an Extensible Markup Language (XML) format.

Save cart icon 208 allows a user to save the current virtual cart. This option becomes active when one or more objects are added to the virtual cart. When this icon is clicked, a dialog box may be displayed that allows the user to specify a name and a path for storing the virtual cart. When the virtual cart is saved, a corresponding cart file that specifies the contents of the virtual cart is stored and may be reopened and/or reused at a later time. In an example embodiment, an XML file may be generated that includes metadata for each of the selected database objects.

Delete row icon 210 allows the user to delete selected objects form the selected objects area 212. When an object is deleted from the select objects area 212, the object is removed from the cart and no longer displayed in selected object area 212. A deleted object will not be loaded into the database cloud service unless it is subsequently added back to the cart before the deployment process begins.

Selected objects area 212 includes objects that have been added to the cart for potential deployment. Information for each selected object is displayed in a list format where each row in the list corresponds to a different selected object. The information about the selected objects may include, without limitation, a name of the respective object, an owner of the object, a type for the object, and a connection from which the object was selected Each row in selected objects area 212 may further comprise an include checkbox and a data checkbox. The include checkbox allows the user to select and deselect all objects or individual objects in selected objects area 212. When the box is checked, the respective object is included in the deployment to the database cloud service. Conversely, when the box is unchecked, the respective object may be excluded from the deployment. The data checkbox allows the data for certain database objects to be included or excluded for the deployment. For example, when the box is checked, the data stored in a database object may be deployed along with a DDL statement for generating the database object. Conversely, when the box is unchecked, the DDL statement for the database object is deployed to the database cloud service, but the data within the database object is not sent or loaded. The WHERE clause field allows the user to optionally specify predicates for filtering data that is deployed from the respective database objects. Only data in the corresponding database object that satisfies the predicate is included in the deployment. For example, if a user has added an employee table to the cart, the user may filter the employee data to deploy to the cloud based on the state of residence of the employee. Thus, only data for employees from a certain location are uploaded to the cloud.

Arrow buttons 214 allow the user to move objects up or down in the order of selected objects area 212. For example, the user may select the table “JOBS” up the list ahead of the other tables by using the up arrow buttons and down the list below the procedure “ADD_JOB_HISTORY” by using the down arrow buttons. The order of the database objects within selected objects area 212 affects the order in which objects are created in the generated scripts that are deployed to the database cloud service.

Script area 216 allows a user to add scripts to the cart. The “Before Script” field allows the user to optionally specify a SQL or PL/SQL script to be processed before any other object included in the cart. The “After Script” field allows the user to optionally specify a SQL or PL/SQL script to be processed after all objects included in the virtual cart.

### Adding Database Objects to the Cart

The manner in which the user adds database objects to the cart may vary from implementation to implementation. In one embodiment, the virtual cart supports a drag and drop interface. For example, the user may add a table or other database object to the virtual cart by moving a pointer over an icon representing the table on one location of a display, grabbing the icon by pressing and holding the button of a pointing device, dragging the icon to the virtual cart at another location of the display, and dropping the table into the virtual cart by releasing the button of the pointing device. Example pointing devices include, without limitation, a mouse, a touchpad, and a touchscreen. When a database object is added to the cart, various information identifying the database object may be displayed in the virtual cart's GUI and the virtual cart file may be updated to include metadata defining the database object.

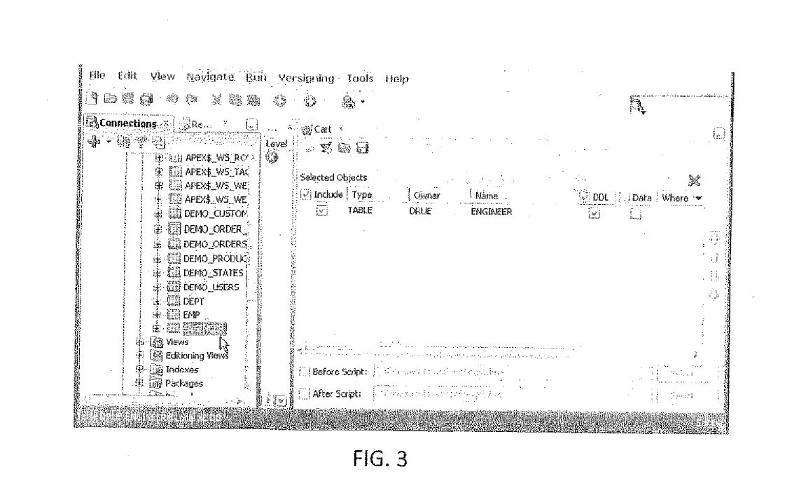

FIG. 3 is a screenshot illustrating an example of adding an object to a virtual cart, according to an embodiment. As illustrated the left side of the screen displays multiple database objects from a non-cloud database connection. The pointer is hovering over a particular icon representing the ENGINEER table. The user may add the ENGINEER table by dragging and dropping the icon into the virtual cart GUI, which is to the right of the connection panel. Once the table is added to the cart, the information about the database object is extracted and displayed in selected objects area 212 of the virtual cart. For example, the “type” field shows that the database object is a table, the “owner” field shows that “DRUE” owns the table, and the “name” field shows that the name of the database object is “ENGINEER.”

As an alternative or in addition to the drag-and-drop method, there may be other methods for adding database objects to the virtual cart. For example, the virtual cart GUI may include an “Add Object” icon that the user may select. In response to selecting the icon, the user may be presented with a dialog box that allows the user to browse for the database object and/or explicitly identify the database object.

### Adding Scripts to the Cart

In an embodiment, a user may add custom scripts to the cart. Example scripts that may be added to the virtual cart and deployed to the database cloud service include, without limitation, SQL scripts, such as Data Definition Language (DDL) and Data Manipulation Language (DML) scripts, and PL/SQL scripts. Accordingly, the user may define and modify database objects by using scripts in addition to the methods for adding objects described above.

The scripts that are included in the cart may also add additional logic to the load process beyond simply deploying database objects. For example, the user may add an employee table to the cart that includes a single name column containing the first and last name for each employee. The user may want to split the column into two separate columns when it is deployed to the database cloud service. Accordingly, the user may write a script that finds the space in between the first and last name and inserts the portion before the space into a first name column and the portion after the space into a last name column. In another example, a script may be added to provide contingencies for whether database objects within the cart are loaded into the database cloud service. For instance, the virtual cart may include an employee table that is being deployed as part of a patch to an application in the database cloud service. The proper operation of the table within the application may be contingent on the existence of another column. A script may be added to the cart that checks to determine whether a particular column exists in a particular table in the database cloud service. If the script detects that the column exists, then the employee table may be loaded into the database cloud service. Otherwise, the script prevents the database cloud service from loading the employee table even though the employee table was part of the virtual cart. Thus, scripts may alter the application logic of how the cart is processed and how the included objects are loaded into the cloud.

The manner in which the scripts are added may vary from implementation to implementation. For example, the user may add scripts to the beginning or end of the data load process by using the interface in script area 216. In another embodiment, the user may drag and drop script objects, such as stored procedures, into the cart similar to the manner database objects are added (e.g., dragging and dropping script objects). In another embodiment, the virtual cart interface may include a text editor for generating and adding the scripts directly within the cart. In yet another embodiment, the cart may include a diff tool that compares the contents of two data objects and generates a script based on the differences between the two. For example, a user may use the diff tool to compare the differences between an older version of a table and an updated version of the table. Based on the comparison, the diff tool may generate a script file comprising one or more INSERT statements for adding new records to the table.

The user may add the scripts to different points of the cart, which represent different stages in the data load process. For example, the user may add the script to the beginning or end of the data load process, before or after a database object is generated, and before or after data is inserted into a data object.

### Generating a Deployment File

During the load process, the database client may generate a deployment file for upload to the database cloud service. The deployment file specifies the objects to be deployed in the database cloud service and the order in which they should be deployed. In an embodiment, the deployment file is a compressed file, such as a ZIP file, that includes a set of one or more files used by the database cloud service to load the objects in the virtual cart into a cloud database. The set of files may include the following: a table of contents file, a set of one or more script files, a set of one or more flat files, and/or a set of one or more loader control files. The table of contents file specifies the order in which the script files and loader control files should be processed by the database cloud service. The script files are files that are generated by the database client for the database objects included in the cart (e.g., DDL scripts) or scripts that have been explicitly added to the cart by the user. The flat files include data that is extracted from the database objects in the cart. The control files specify how the data in the flat files should be loaded into the database objects by the database cloud service.

For example, a deployment file may be generated for the virtual cart depicted in FIG. 2B as follows. For each database object, the database client generates a DDL script. If the data check box is checked, the database client also generates a set of one or more flat files for the data stored in the corresponding database object and a set of one or more control files (e.g., a SQL*Loader control file) specifying where to find the data and how to load the data into the database object. Thus, a DDL script is generated to create the EMPLOYEES, JOB_HISTORY, and JOBS tables. The database client may flatten out the data in each of these tables into a set of flat files and generate corresponding SQL*Loader control files for each table. Once all the scripts are generated, the database client may then generate a table of contents specifying an order in which the scripts should be processed. In general, the scripts are processed based on the sequencing of objects within the cart. Thus, the table of contents directs the database cloud service to process the script to generate the EMPLOYEES table first, followed by the script to generate the JOB_HISTORY table, followed by the script to generate the JOBS table, followed by the stored procedure ADD_JOB_HISTORY. If a before script is specified in script area 216, then the table of contents directs the database cloud service to process this script before any other script for objects in the cart. If an after script is specified in script area 216, then the table of contents directs the database cloud service to execute this script after the other scripts for objects in the cart have been processed. Once the table of contents, script files, flat files, and control files have been generated, the database client compresses the files into a single zip file.

### Example Data Load Process

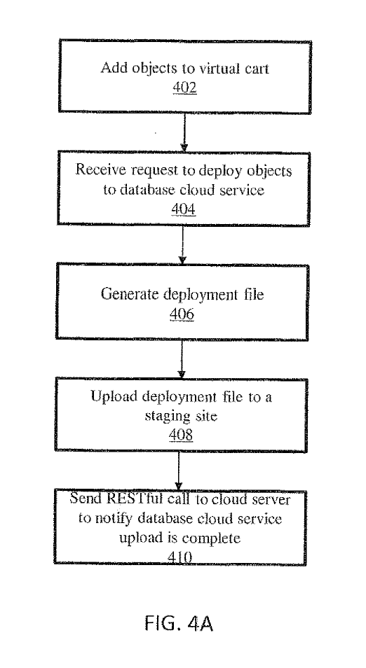

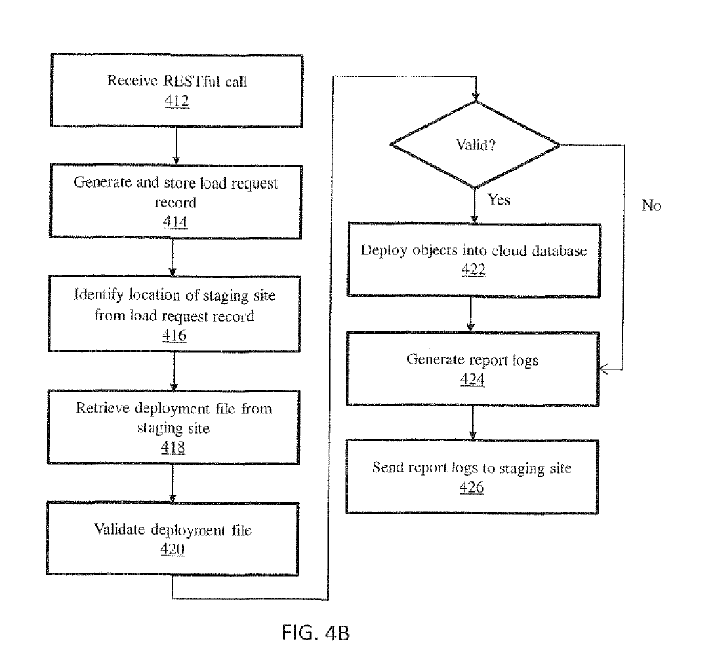

FIGS. 4A and 4B are flowcharts illustrating example processes for loading data into a database cloud service, according to an embodiment. FIG. 4A is a flowchart illustrating an example process for identifying objects to be loaded into the database cloud service, according to an embodiment. In step 402, one of clients 112a to 112n receives user input adding objects to a virtual cart. For example, the user may drag and drop database objects and/or ancillary scripts as described in detail above. During this step, the user may also reorder the contents of the cart based on the sequence the user would like the contents to be processed by the database cloud service. Once the user has included all objects in the cart in the sequence that the user desires, the cart is ready for deployment.

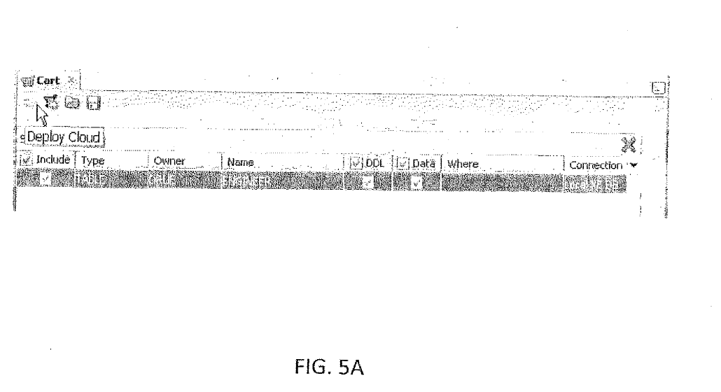

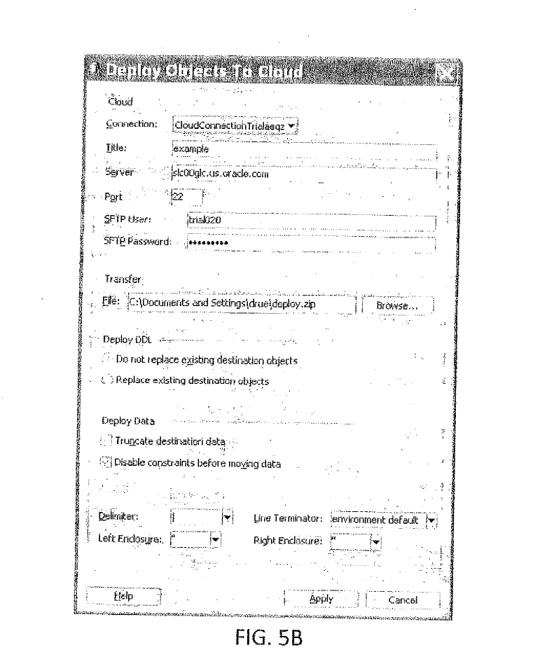

In step 404, the client receives user input requesting deployment of the virtual cart. FIGS. 5A and 5B are screenshots illustrating an example interface for deploying contents of a virtual cart to a database cloud service, according to an embodiment. In FIG. 5A, the user requests deployment of the objects in the virtual cart by clicking on deploy cloud icon 202. In response, the dialog box illustrated in FIG. 5B may be presented to the user. The dialog box may prompt the user for information related to the deployment. Example information may include, without limitation, a name for the deployment, a server name and port used for the deployment, and a username and password for accessing the consumer's staging site.

In step 406, the client generates a deployment file for the virtual cart. The deployment file may include a table of contents, script files, flat files, and/or control files as described in detail above.

In step 408, the deployment file is uploaded to a staging site associated with the user. During this step, the client may transfer the deployment file according to an encrypted FTP network protocol. Examples include, without limitation, the SSH File Transfer Protocol or the SSL/TLS File Transfer Protocol.

In step 410, the client makes one or more RESTful calls to a server within the database cloud service. For example, the client may send an HTTP request indicating that a deployment file has been uploaded to one of staging sites 160a to 160n and requesting that the database cloud service process the deployment file. The HTTP request may identify the staging site, the name of the deployment file, and/or the size of the deployment file. The HTTP request may further identify a target location in a cloud database (e.g., within databases 150a to 150n) where the database objects should be deployed. To identify the target location, the HTTP request may include a URL as described in CLOUD DATABAE CONNECTION MULTIPLEXING.

FIG. 4B is a flowchart illustrating an example process for loading data included in a deployment file, according to an embodiment. In step 412, web server 142 receives one or more RESTful calls sent by the client at step 410.

In step 414, web server 142 generates and stores a load request in a work queue of the administrative database. In an embodiment, web server 142 comprises a listener process that triggers whenever a RESTful call is received from a client. When the RESTful call indicates that the database client has uploaded the deployment file to the staging site, the listener process inserts a record into the administrative database that includes information about the deployment file. The database record may include, without limitation, a timestamp for when the upload completed, the size of the deployment file, the location of the file, and the consumer associated with the deployment file.

In step 416, application server 144 processes the load request record to identify the location of the deployment file. During this step, application server 144 may periodically poll the administrative database to determine whether any new load requests have been received. Upon detecting a new record, application server 144 may process the record to determine the location of the deployment file and a target location in a database for loading the data.

In step 418, application server 144 retrieves the deployment file from the staging area. For example, application server 144 may download the deployment file from an FTP site where the file is stored.

In step 420, the server validates the deployment file. This step may comprise performing a set of one or more validations tests on the deployment file. For example, the server may determine from metadata included in the deployment file whether it was generated by a recognized application. If the deployment file was not created using the virtual cart, then the deployment file may be rejected. Similarly, the deployment file may be rejected if it is in a format that the server does not recognize. In another embodiment, the server verifies that the timestamp and size of the deployment file match the timestamp and size indicated in the load request record. If either attribute does not match, then the deployment file may be rejected. In yet another embodiment, the deployment file may be scanned for viruses. If a virus is detected, then the deployment file may be rejected. When the deployment file is rejected, the server may skip processing of the deployment file at step 422 so that none of the objects in the rejected deployment file are loaded into the cloud database. Instead, the process may continue to step 424, and the server may generate failure logs to indicate the reasons the deployment file was rejected.

If the deployment file is validated, then the process continues to step 422, and application server 144 deploys the objects into the cloud database. This step may comprise decompressing the deployment file to extract the table of contents, script files, control files, and flat files. The target database system runs the scripts and loads the data in the order indicated by the table of contents. For example, a database server may process the virtual cart in FIG. 2B as follows. The server may process a DDL script to generate an EMPLOYEES table. Once the table is generated in the cloud database, the server may run a SQL loader control file to load data from one or more flat files into the EMPLOYEES table. The server may then repeat this process for respective scripts and control files for the JOB_HISTORY and JOBS tables to deploy these object to the cloud database. At the end, the server may process the ADD_JOB_HISTORY procedure.

In step 424, application server 144 and/or the target database system generates report logs to indicate the deployment status of the objects in the virtual cart. Logs may be generated for each stage of the deployment process. For example, a log may be generated to indicate whether the validation process has approved or rejected the deployment file. Similarly, a log may be generated to indicate whether creating a database object, loading a data into the database object, and/or running a user-generated script was successful or not. The information included in the log data may vary from implementation to implementation. Example information may include, without limitation, data identifying each record that did not deploy and why the particular record failed to deploy.

In step 426, application server 144 sends the report logs to the user's staging site. During this step, application server 144 may compress the log files before uploading the log files to the staging site. Once uploaded to the consumer's staging site, a user, via one of clients 112a to 112n, may download the logs generated by the database cloud service to view the log data.

### Monitoring a Deployment

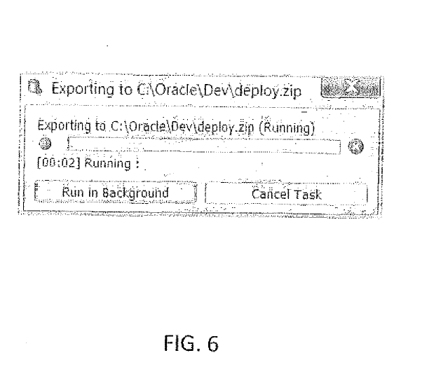

Once a cart deployment has been initiated, the user may monitor the status of the load process. FIG. 6 is a screenshot of an export dialog that tracks the export status of a deployment file, according to an embodiment. When the user clicks on the “Apply” button depicted in FIG. 5B, the generation and upload of the deployment file to the consumer's staging site begins. The export dialog depicted in FIG. 6 may then be presented to the user to show the status of the task. During this process, the user may cancel the task or run the process in the background.

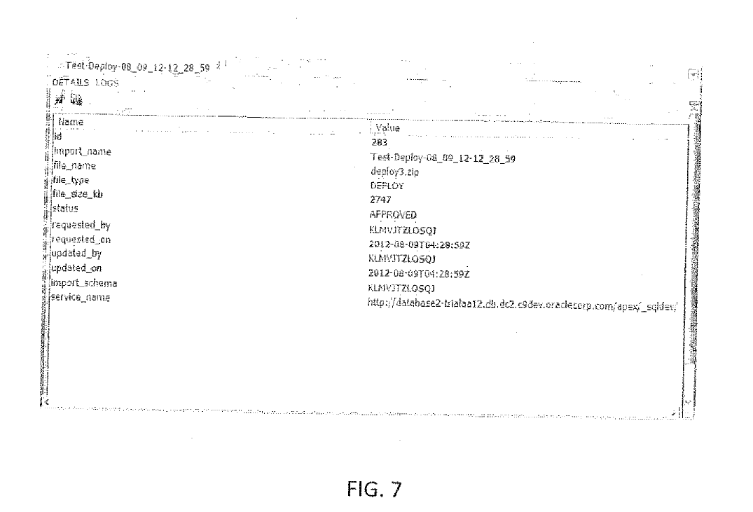

When the upload of the deployment file to the staging site completes, the server automatically begins the process of validating the file and loading the contents of the file into a cloud database. During this process, the server may send status updates to the client to indicate whether the deployment file was successfully validated. These status updates may be displayed to the user through a GUI on the client. FIG. 7 is a screenshot depicting an example interface for displaying the status of a deployment, according to an embodiment. A deployment window lists various information associated with the deployment, including the name of the deployment file and the status of the deployment. Once the deployment file has been successfully validated, the status listed in the window is changed from PENDING to APPROVED. If the validation process fails (e.g., a virus is detected, the deployment file was not properly generated, the deployment file did not properly upload, user authentication was unsuccessful, etc.), then the status may be changed to FAILED VERIFICATION. After the deployment file is approved, a background process in the database cloud service begins running the scripts (e.g., SQL commands) in the deployment file. Once the background process begins running the scripts, the status in the deployment window depicted n FIG. 7 may be changed from APPROVED to PROCESSING. Thus, the PROCESSING status indicates that the background daemon process found the APPROVED deployment and has initiated processing of the deployment file.

Once the data load job is complete, the status changes from PROCESSING to PROCESSED. This indicates that report logs have been stored in the consumer's staging site. The consumer may download the logs from the staging site to view a detailed report of the deployment process. For example, the logs may include a listing of the completed steps that occurred at step 422. The logs may list all SQL commands that were run in the order that they were processed. If there were rows or other items of data that were not inserted as part of the load, these items may be specifically identified in the log files.

### Reusing a Cart

Once a cart has been saved, the user may re-run a deployment by opening the cart and selecting to deploy the cart from the cart's interface, as described above, or by running the cart deployment from a command line interface. The ability to reuse the cart may save the user time from having to regenerate the cart each time the user would like to deploy items within the cart to the cloud. For example, the user may reuse the same cart to update sales tables, employee tables, or other objects as they change over time.

The user may also schedule periodic deployments for carts that have been saved. For example, the user may generate a cart named DAILY_SALES. The user may predicate the data that is uploaded based on a date associated with the data (e.g., include only sales data for the current day). The user may then schedule the cart to run every day just before midnight to upload that days sale data to the database cloud service. Similarly, the user may run a weekly sales cart on a weekly basis or a monthly sales cart on a monthly basis, etc.

The user may also have the option of restarting a deployment that is currently in progress. This option may be useful if the deployment failed to properly load table structures or data for some correctable reason, such as where duplicate values for a unique primary key were detected.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

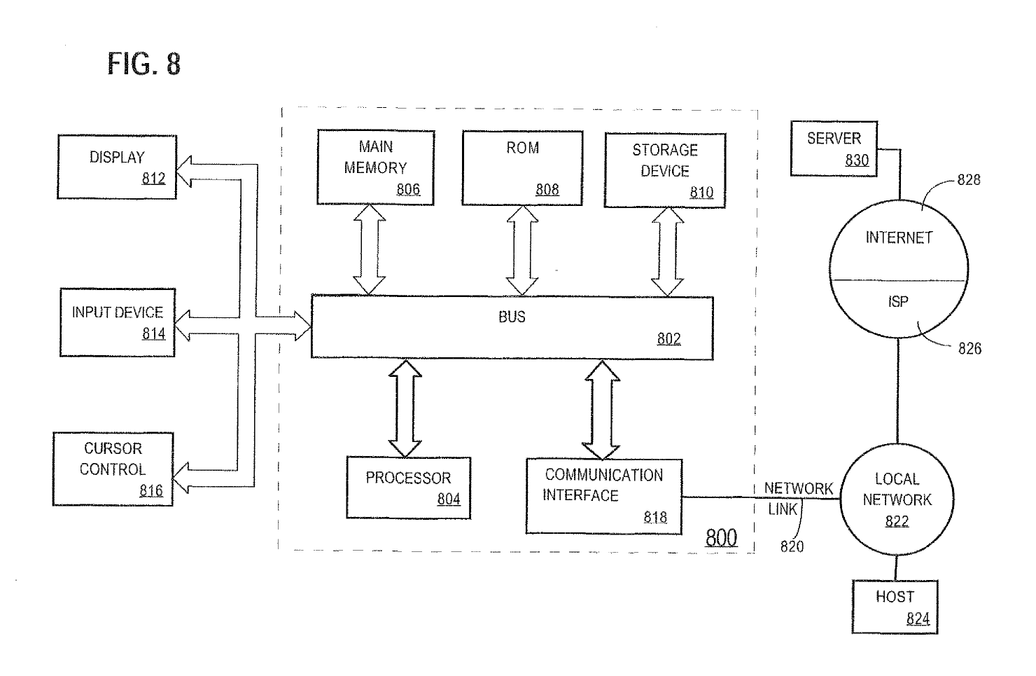

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Extensions and Alternatives

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for deploying database objects to a database cloud service, the method comprising:
in response to first user input, adding one or more database objects to a virtual cart;
in response to second user input, deploying the one or more database objects to the database cloud service:
wherein deploying the one or more database objects to the database cloud service comprises:
generating, based at least in part on the one or more database objects in the virtual cart, a set of one or more files for loading the database objects into a target database associated with the database cloud service;
sending the set of one or more files to the database cloud service.

2. The method of claim 1, wherein the first user input comprises:
a user moving a pointer over an icon on one location of a display;
wherein the icon represents a particular database object associated with a non-cloud database connection;
the user selecting the icon using a pointing device;
the user dragging the icon to a graphical user interface of the virtual cart at another location of the display;
the user dropping the database object into the virtual cart using the pointing device.

3. The method of claim 1, further comprising:
in response to third user input, adding one or more scripts to the virtual cart;
wherein the one or more scripts are added before receiving the second user input;
wherein the one or more scripts affect a flow with which the one or more database objects are deployed to the database cloud service.

4. The method of claim 1,
wherein the set of one or more files includes a set of one or more scripts for generating the one or more database objects and a table of contents identifying an order for processing the set of one or more scripts;
wherein the order for processing the set of one or more scripts is based on an order of the one or more database objects within the virtual cart.

5. The method of claim 1, further comprising:
in response to third user input, associating a predicate with at least one database object of the one or more database objects in the virtual cart;
wherein deploying the one or more database objects to a database cloud service further comprises:
loading only data for the at least one database object into the database cloud service that satisfies the predicate.

6. The method of claim 1,
wherein sending the set of one or more files to the database cloud service causes the database cloud service to perform a set of one or more validation tests on the set of one or more files;
wherein the database cloud service does not load at least a portion of the one or more database objects if the set of one or more files fails at least one validation test of the set of one or more validation tests.

7. The method of claim 1, further comprising:
receiving status updates from the database cloud service identifying a status associated with deploying the one or more database objects to the database cloud service;
causing the status associated with deploying the one or more database objects to the database cloud service to be displayed to a user.

8. The method of claim 1, further comprising:
in response to third user input, scheduling the one or more database objects in the virtual cart to be deployed to the database cloud service at periodic intervals.

9. One or more non-transitory computer-readable media storing instructions, which, when executed by one or more processors, cause one or more computing devices to perform:
in response to first user input, adding one or more database objects to a virtual cart;
in response to second user input, deploying the one or more database objects to a database cloud service:
wherein instructions for deploying the one or more database objects to the database cloud service comprise instructions for:
generating, based at least in part on the one or more database objects in the virtual cart, a set of one or more files for loading the database objects into a target database associated with the database cloud service;
sending the set of one or more files to the database cloud service.

10. The non-transitory computer-readable media of claim 9, wherein the first user input comprises:
a user moving a pointer over an icon on one location of a display;
wherein the icon represents a particular database object associated with a non-cloud database connection;
the user selecting the icon using a pointing device;
the user dragging the icon to a graphical user interface of the virtual cart at another location of the display;
the user dropping the database object into the virtual cart using the pointing device.

11. The non-transitory computer-readable media of claim 9, further comprising instructions, which, when executed by one or more processors, cause one or more computing devices to perform:
in response to third user input, adding one or more scripts to the virtual cart;
wherein the one or more scripts are added before receiving the second user input;
wherein the one or more scripts affect a flow with which the one or more database objects are deployed to the database cloud service.

12. The non-transitory computer-readable media of claim 9,
wherein the set of one or more files includes a set of one or more scripts for generating the one or more database objects and a table of contents identifying an order for processing the set of one or more scripts;
wherein the order for processing the set of one or more scripts is based on an order of the one or more database objects within the virtual cart.

13. The non-transitory computer-readable media of claim 9, further comprising instructions, which, when executed by one or more processors, cause one or more computing devices to perform:
in response to third user input, associating a predicate with at least one database object of the one or more database objects in the virtual cart;
wherein instructions for deploying the one or more database objects to a database cloud service further comprises instructions for:
loading only data for the at least one database object into the database cloud service that satisfies the predicate.

14. The non-transitory computer-readable media of claim 9,
wherein sending the set of one or more files to the database cloud service causes the database cloud service to perform a set of one or more validation tests on the set of one or more files;
wherein the database cloud service does not load at least a portion of the one or more database objects if the set of one or more files fail at least one validation test of the set of one or more validation tests.

15. The non-transitory computer-readable media of claim 9, further comprising instructions, which, when executed by one or more processors, cause one or more computing devices to perform:
receiving status updates from the database cloud service identifying a status associated with deploying the one or more database objects to the database cloud service;
causing the status associated with deploying the one or more database objects to the database cloud service to be displayed to a user.

16. The non-transitory computer-readable media of claim 9, further comprising instructions, which, when executed by one or more processors, cause one or more computing devices to perform:
in response to third user input, scheduling the one or more database objects in the virtual cart to be deployed to the database cloud service at periodic intervals.

17. A system for routing requests deploying database objects to a database cloud service, the system comprising:
one or more processors;
one or more non-transitory computer-readable media storing instructions, which, when executed by the one or more processors, cause one or more computing devices to perform:
in response to first user input, adding one or more database objects to a virtual cart;
in response to second user input, deploying the one or more database objects to a database cloud service:
wherein instructions for deploying the one or more database objects to the database cloud service comprise instructions for:
generating, based at least in part on the one or more database objects in the virtual cart, a set of one or more files for loading the database objects into a target database associated with the database cloud service;
sending the set of one or more files to the database cloud service.

18. The system of claim 17, wherein the first user input comprises:
a user moving a pointer over an icon on one location of a display;
wherein the icon represents a particular database object associated with a non-cloud database connection;
the user selecting the icon using a pointing device;
the user dragging the icon to a graphical user interface of the virtual cart at another location of the display;
the user dropping the database object into the virtual cart using the pointing device.

19. The system of claim 17, further comprising instructions, which, when executed by one or more processors, cause one or more computing devices to perform:
in response to third user input, adding one or more scripts to the virtual cart;
wherein the one or more scripts are added before receiving the second user input;
wherein the one or more scripts affect a flow with which the one or more database objects are deployed to the database cloud service.

20. The system of claim 17,
wherein the set of one or more files includes a set of one or more scripts for generating the one or more database objects and a table of contents identifying an order for processing the set of one or more scripts;
wherein the order for processing the set of one or more scripts is based on an order of the one or more database objects within the virtual cart.

21. The system of claim 17, further comprising instructions, which, when executed by one or more processors, cause one or more computing devices to perform:
in response to third user input, associating a predicate with at least one database object of the one or more database objects in the virtual cart;
wherein instructions for deploying the one or more database objects to a database cloud service further comprises instructions for:
loading only data for the at least one database object into the database cloud service that satisfies the predicate.

22. The system of claim 17,
wherein sending the set of one or more files to the database cloud service causes the database cloud service to perform a set of one or more validation tests on the set of one or more files;
wherein the database cloud service does not load at least a portion of the one or more database objects if the set of one or more files fail at least one validation test of the set of one or more validation tests.

23. The system of claim 17, further comprising instructions, which, when executed by one or more processors, cause one or more computing devices to perform:
receiving status updates from the database cloud service identifying a status associated with deploying the one or more database objects to the database cloud service;
causing the status associated with deploying the one or more database objects to the database cloud service to be displayed to a user.

24. The system of claim 17, further comprising instructions, which, when executed by one or more processors, cause one or more computing devices to perform:
in response to third user input, scheduling the one or more database objects in the virtual cart to be deployed to the database cloud service at periodic intervals.
